(19) United States
(12) Patent Application Publication
(10) Pub. No.: US 2011/0019515 A1
(43) Pub. Date: Jan. 27, 2011

(54) METHOD OF MANAGING DATA IN OPTICAL DISC APPARATUS

(75) Inventor: Chang Whan JURNG, Seoul (KR)

Correspondence Address: BIRCH STEWART KOLASCH & BIRCH, PO BOX 747, FALLS CHURCH, VA, 22040-0747, US

(73) Assignee: HITACHI-LG DATA STORAGE KOREA, INC., Seoul (KR)

(21) Appl. No.: 12/843,486

(22) Filed: Jul. 26, 2010

(30) Foreign Application Priority Data
Jul. 27, 2009 (KR) 10-2009-0068429

(51) Int. Cl. G11B 7/00

(52) U.S. Cl. 369/47.15; G9B/20; G9B/7

(57) ABSTRACT

A method of managing data in an optical disc apparatus is provided. The type of a loaded disc is checked, and data corresponding to the checked disc type is read from a compressed file, decompressed and stored in a memory of the optical disc apparatus. Recording-related data respectively corresponding to disc types, manufacturers, and recording speeds are separately compressed in the compressed file. Identification information about the disc types, manufacturers, and recording speeds and information on positions at which the recording-related data about the disc types, manufacturers, and recording speeds are stored may be included in the head of the compressed file. The compressed file may include separately compressed servo data, and information on the position at which the servo data is stored may be included in the head of the compressed file. Accordingly, the optical disc manufacturing cost can be decreased and a data loading time can be reduced.

This nonprovisional application claims priority under 35 U.S.C. §119(a) on Patent Application No. 10-2009-0068429 filed in Republic of Korea on Jul. 29, 2009 the entire contents of which are hereby incorporated by reference.

### BACKGROUND

1. Field

This document relates to a method of effectively managing data used in an optical disc apparatus.

2. Related Art

Data required to play or record various optical disc media are stored and managed in an optical disc drive that records data on optical discs such as CD, DVD, BD, etc. or reads the data from the optical discs.

A flash ROM included in the optical disc drive stores write strategy tables for CD media, write strategy tables for DVD media, and strategy table for BD media.

When the optical disc drive is booted, the write strategy tables stored in the flash ROM are read and loaded to a DRAM included in the optical disc drive.

The optical disc drive checks the type of an inserted optical disc and performs an operation of recording data on the optical disc using the write strategy table corresponding to the checked disc type.

However, since the number of disc types increases, a flash ROM with large capacity is needed to store all the write strategy tables corresponding to various types of optical discs and a long time is required to load all the write strategy tables stored in the flash ROM to the DRAM during system booting.

### SUMMARY

An aspect of this document is to provide a method of effectively managing data stored in an optical disc apparatus and memories included in the optical disc apparatus.

In an aspect, a method of managing data in an optical disc apparatus comprises checking the type of a loaded disc, and reading data about the disc type from a compressed file, decompressing the data and storing the decompressed data in a memory of the optical disc apparatus.

In another aspect, an optical disc apparatus comprises an optical pickup recording data on an optical disc or reading data from the optical disc using a laser beam; a recording/playback system driving a spindle motor, a sled motor, and the optical pickup and processing servo signals and recording/playback data; a ROM storing a compressed file; a RAM temporarily storing data; and a controller controlling the recording/playback system, wherein the controller controls the recording/playback system to check the type of a loaded disc, read data about the checked disc type from the compressed file, decompress the read data and store the decompressed data in the RAM.

In an embodiment, the compressed file may include recording-related data about a plurality of disc types and the recording-related data may be separately compressed in the compressed file. Information representing positions at which the recording-related data about the disc types are stored may be included in the head of the compressed file.

In an embodiment, recording-related data respectively corresponding to disc types, manufacturers, and recording speeds may be separately compressed in the compressed file. Default recording-related data about the disc types may be compressed in the compressed file. Identification information about the disc types, manufacturers, and recording speeds and information on positions at which the recording-related data about the disc types, manufacturers and recording speeds are stored may be included in the head of the compressed file.

In an embodiment, the compressed file may include servo data compressed separately from the data about the disc types, and position information on the position at which the servo data is stored may be included in the head of the compressed file. The servo data may be selectively read from the compressed file based on the position information, decompressed and stored in the memory.

In an embodiment, a requested recording operation may be performed based on the data about the disc types, stored in a RAM of the optical disc apparatus.

Accordingly, the optical disc drive manufacturing cost can be reduced since an expensive ROM with large capacity is not required. Furthermore, it is not required to load data about every disc to the RAM, and thus a loading time can be decreased.

### BRIEF DESCRIPTION OF THE DRAWINGS

The implementation of this document will be described in detail with reference to the following drawings in which like numerals refer to like elements.

FIG. 1 illustrates a configuration of an optical disc apparatus to which this document is applied;

FIG. 2 illustrates an embodiment of a compressed file stored in a specific area of a ROM according to this document;

FIG. 3 is a flowchart illustrating a method of managing data in an optical disc apparatus according to an embodiment of this document; and

FIG. 4 illustrates an embodiment of loading recording-related data read from a specific area of a ROM to a specific area of a RAM according to this document.

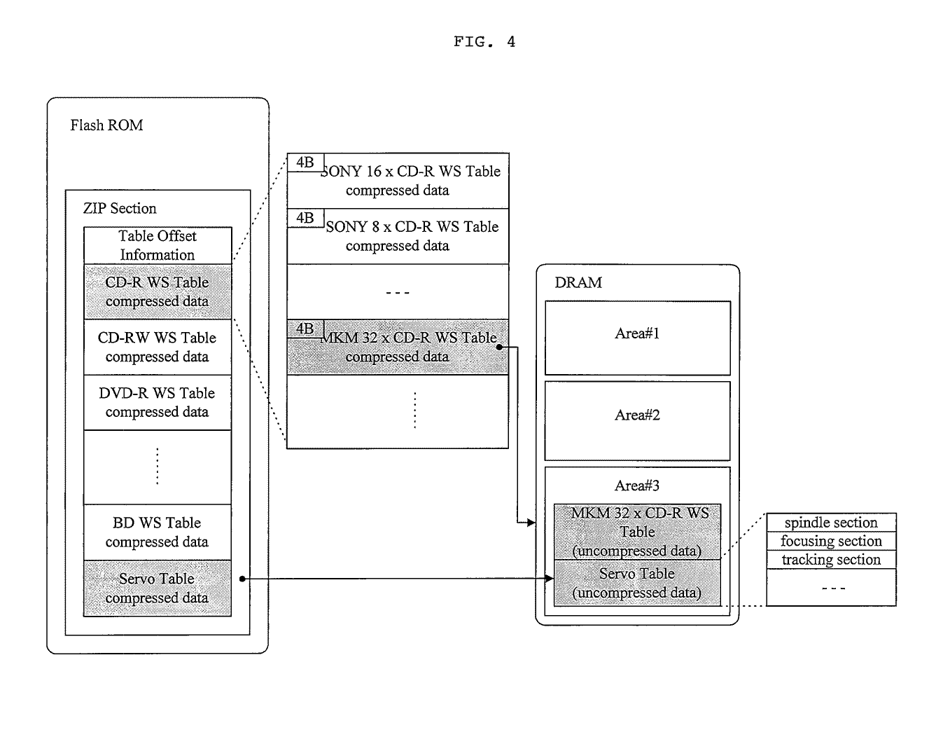

### DETAILED DESCRIPTION

Hereinafter, an implementation of this document will be described in detail with reference to the attached drawings.

A method of managing data in an optical disc apparatus according to this document can be applied to an optical disc drive that records data on various types of optical discs, such as CD, DVD, BD, etc. or reproduces data from the optical discs.

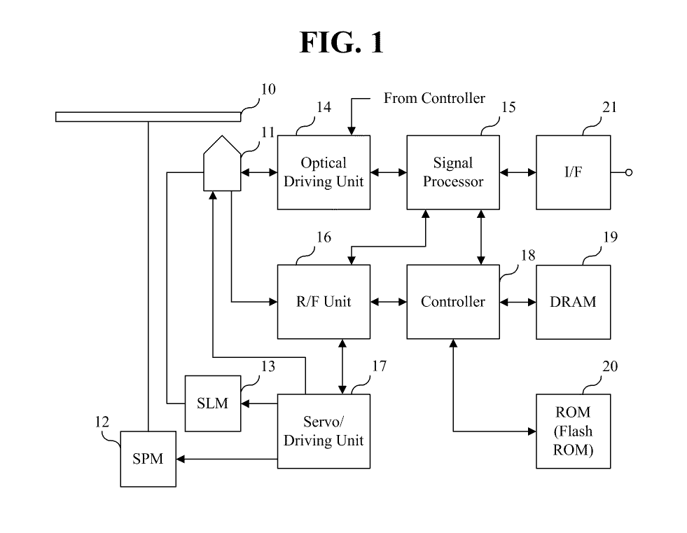

Referring to FIG. 1, an optical disc apparatus to which this document is applied may include an optical pickup 11 which records data on an optical disc or reads data from the optical disc using a laser beam, a spindle motor 12, a sled motor 13, a recording/playback system which drives the optical pickup 11, the spindle motor 12, and the sled motor 13 and processes servo signals and recording/playback data, a controller 18 which controls the recording/playback system, a memory, and an interface 21. The recording/playback system may include an optical driving unit 14, a signal processor 15, an R/F unit 16, and a servo/driving unit 17. The optical driving unit 14 may be included in the optical pickup 11. The memory may include a RAM 19 and a ROM 20.

The RAM 19 may use a DRAM and the ROM 20 may use a flash ROM. The ROM 19 stores data about optical discs, for example, data related to recording (the number, positions, power levels of recording pulses, etc.). The data about optical discs may be compressed into a single file and stored in a specific area in the ROM 20.

Raw data files respectively corresponding to write strategy tables of CDs, write strategy tables of DVDs, write strategy tables of BDs, and a servo table are generated. For discs of the same type, for example, DVDs, write strategy tables respectively corresponding to various media types, such as DVD-R, DVD-RW, DVD+R, DVD+RW, and DVD-RAM, may be generated as separate row data files.

The raw data files are separately compressed to generate a single compressed file (for example, WSZIP.bin) and the compressed file is stored in a specific area, for example, a ZIP section, in the ROM 20.

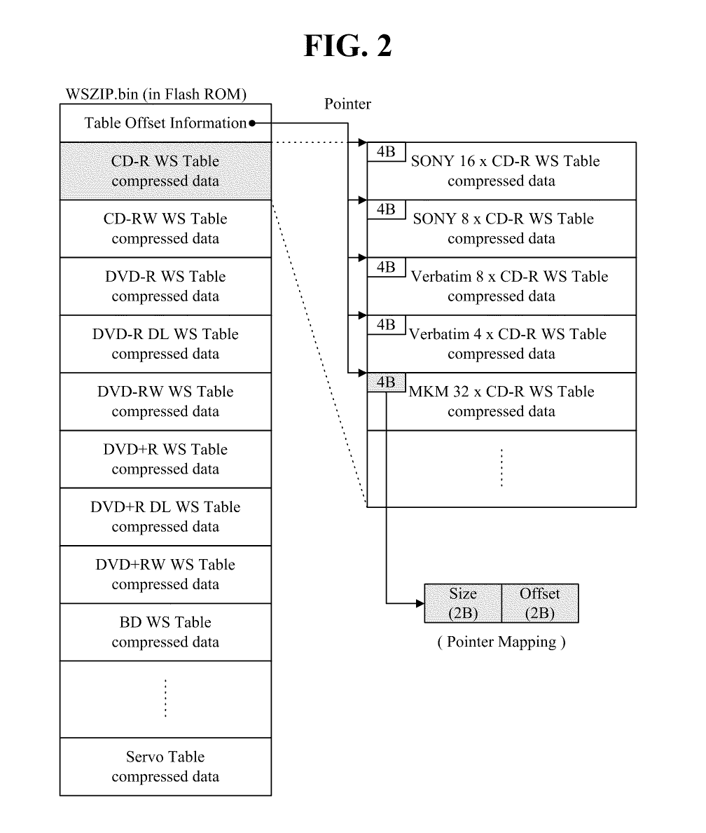

Table offset information representing the position of a table corresponding to each media (position in the compressed file) is affixed to the head of the compressed filed stored in the ZIP section in the ROM 20, for example, WSZIP.bin, as shown in FIG. 2, and the write strategy table corresponding to each media and the servo table are stored as compressed data in the compressed file.

The write strategy table for each media may include write strategy tables respectively corresponding to media manufacturers and recording speeds related to the media. For example, a CD-R write strategy table may include a SONY 16× CD-R write strategy table, a SONY 8× CD-R write strategy table, a Verbatim 8× CD-R write strategy table, a Verbatim 4× CD-R write strategy table, a MKM 32× CD-R write strategy table, etc. The CD-R write strategy table may further include a default write strategy table applicable irrespective of the manufacturers.

The table offset information included in the head of the compressed file WSZIP.bin may include information on positions of tables with respect to manufacturers and recording speeds for each media type. For example, the table offset information about a CD-R may include identification information representing the CD-R and the entire size of the table with respect to the CD-R. Furthermore, the table offset information about the CD-R may include manufacturer ID of manufacturers and information on recording speeds for individual manufactures and recording speeds of CD-R type. In addition, the table offset information about the CD-R may include position information on the positions of write strategy tables corresponding to the manufacturers and recording speeds in the form of pointers or offsets that indicate positions in the compressed file. Moreover, the table offset information about the CD-R may further include information on positions at which default write strategy tables respectively corresponding to the recording speeds are recorded irrespective of the manufacturers.

In the head of the write strategy table corresponding to each media, the size and offset of the table are respectively recorded in 2 bytes. The 2-byte offset may be recorded as a mapping value corresponding to the pointer included in the table offset information.

A module that performs a decompression operation of extracting data from the compressed file may be separately stored in the ROM 20 and referred to by a program executed in the optical disc apparatus. Otherwise, a module having a decompression function may be added to firmware to decompress the compressed file WSZIP.bin.

The controller 18 checks the media type of an optical disc inserted into the optical disc drive, selectively reads the write strategy table corresponding to the checked media type from WSZIP.bin stored in the ZIP section in the ROM 20, decompresses the read write strategy table and loads the decompressed write strategy table to a specific area in the RAM 19.

When power is applied to the optical disc drive, the controller 18 reads the servo table stored in the form of compressed data in WSZIP.bin of the ROM 20, decompresses the servo table into uncompressed data and loads the uncompressed data to a specific area of the RAM 19. The uncompressed data is used for a disc playback operation or a disc recording operation. The table offset information may include position information of the servo table and, additionally, size information of the servo table.

The write strategy table loaded in the specific area of the RAM 19 may be used when data requested by a user is recorded on the inserted optical disc. The controller 18 performs the operation of checking the media type of a disc loaded into a tray of the optical disc apparatus, selectively reading the write strategy table corresponding to the checked media type from WSZIP.bin file stored in the ZIP section of the ROM 20, decompressing the read write strategy table into uncompressed data and loading the uncompressed data to the specific area of the RAM 19 whenever an optical disc is inserted into the optical disc apparatus or whenever power is applied to the optical disc apparatus.

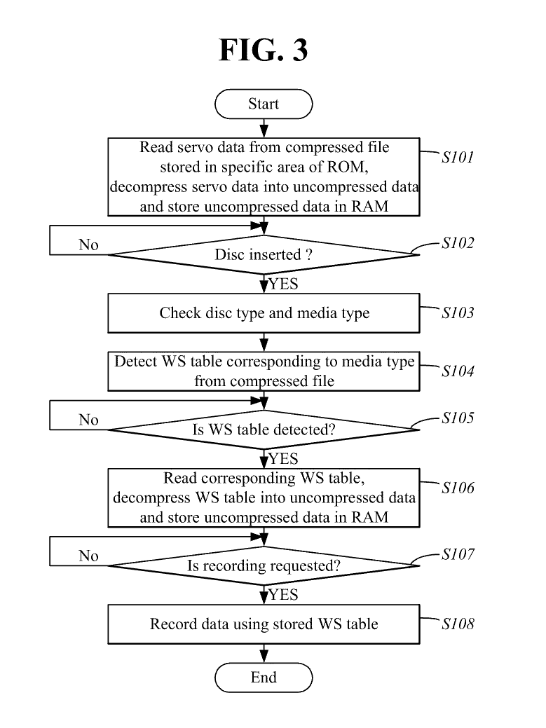

FIG. 3 is a flowchart illustrating a method of managing data in an optical disc apparatus according to an embodiment of this document.

Raw data files respectively corresponding to write strategy tables and a servo table are separately compressed to generate a single compressed file (for example, WSZIP.bin). The single compressed file is stored in a specific area, for example, a ZIP section, in the ROM 20.

The write strategy tables and the servo table may be stored as a compressed file in the ROM 20 when the optical disc apparatus is released. Otherwise, a compressed file of the newest write strategy tables and servo table may be stored with the help of an application of a host when firmware of the optical disc apparatus is updated.

When power is applied to the optical disc apparatus, the controller 18 selectively reads the servo table from the compressed file stored in the ZIP section in the ROM 20, decompresses the read servo table into uncompressed data and stores the uncompressed data in a specific area in the RAM 19 in operation S101. Here, the controller 18 may confirm the position and/or the size of the servo table from table offset information included in the head of the compressed file and read the servo table from the confirmed position in the compressed file.

The servo table includes servo control data including spindle servo, focusing servo, tracking servo, etc. The servo control data can be applied to a playback operation or a recording operation requested by a user.

The operation of reading the servo table and storing the read servo table in the RAM 19 may be performed simultaneously with an operation of loading a write strategy table, which will be executed later, or carried out independently of the loading operation.

When an optical disc is inserted into the optical disc drive in operation S102, the controller 18 controls the elements of the optical disc apparatus to check the disc type and media type of the optical disc in operation S103. For example, the controller 18 checks whether the inserted optical disc corresponds to CD, DVD or BD and whether the media type of the inserted optical disc corresponds to ROM, +/−R, +/−RW, RAM or dual layer. The operation of checking the disc type and media type of the optical disc is well-known so that detailed description is omitted. Here, the disc type or the media type may be used solely as a term to classify CD-ROM, CD-R, CD-RW, DVD-ROM, DVD-R, DVD+R, DVD-RW, DVD+RW, DVD-RAM, BD-ROM, BD-R, BD-RW, etc.

The controller 18 does not only check the media type of the optical disc but also confirms information recorded on the optical disc. For example, the controller confirms the manufacturer and recording speed information of the optical disc (when the optical disc is a disc for recording) based on manufacture ID.

The controller 18 detects the write strategy table corresponding to the checked media type from the compressed file stored in the ZIP section of the ROM. If the optical disc is a 32× CD-R disc manufactured by MKM, for example, the controller 18 detects the write strategy table corresponding to the MKM 32× CD-R disc from the compressed file stored in the ZIP section of the ROM 20 in operation S104.

The controller 18 can confirm whether the write strategy table corresponding to the checked media type, manufacturer and recording speed information is included in the compressed file and the position at which the write strategy table is recorded in the compressed file from the table offset information included in the head of the compressed file.

When the write strategy table corresponding to the MKM 32× CD-R is detected S105, the controller 18 selectively reads the write strategy table corresponding to the MKM 32× CD-R from the confirmed position in the compressed file, decompresses the read write strategy table into uncompressed data, and loads the uncompressed data to the specific area of the RAM 19 in operation S106.

When a data recording request is received from a user in operation S107, the controller 18 performs an operation of recording data on the optical disc 10 using the write strategy table of the MKM 32× CD-R and the servo table, which are loaded in the specific area of the RAM 19 in the form of uncompressed data, in operation S108.

When the write strategy table corresponding to the manufacturer and/or the recording speed of the inserted optical disc is not detected in operation S105, the controller 18 may detect information on the position at which the default write strategy table corresponding to the media type of the inserted optical disc from the table offset information included in the head of the compressed file, read the default write strategy table from the confirmed position, decompress the read default write strategy table and record the decompressed default write strategy table in the RAM 19.

While this document has been described in connection with what is presently considered to be practical exemplary embodiments, it is to be understood that this document is not limited to the disclosed embodiments, but, on the contrary, is intended to cover various modifications and equivalent arrangements included within the spirit and scope of the appended claims.

What is claimed is:

1. A method of managing data in an optical disc apparatus, comprising:
checking the type of a loaded disc; and
reading data about the disc type from a compressed file, decompressing the data and storing the decompressed data in a memory of the optical disc apparatus.

2. The method of claim 1, wherein the compressed file includes recording-related data about a plurality of disc types and the recording-related data are separately compressed in the compressed file.

3. The method of claim 2, wherein information representing positions at which the recording-related data about the disc types are stored is included in the head of the compressed file.

4. The method of claim 2, wherein recording-related data respectively corresponding to disc types, manufacturers, and recording speeds are separately compressed in the compressed file.

5. The method of claim 4, wherein default recording-related data about the disc types are compressed in the compressed file.

6. The method of claim 4, wherein identification information about the disc types, manufacturers, and recording speeds and information on positions at which the recording-related data about the disc types, manufacturers and recording speeds are stored are included in the head of the compressed file.

7. The method of claim 1, wherein the compressed file includes servo data compressed separately from the data about the disc types, and position information on the position at which the servo data is stored is included in the head of the compressed file, the method further comprising selectively reading the servo data from the compressed file based on the position information, decompressing the servo data and storing the decompressed servo data in the memory.

8. The method of claim 1, further comprising:
performing a requested recording operation using the data about the disc type, stored in a RAM of the optical disc apparatus.

9. The method of claim 1, wherein the compressed file has been stored in a ROM of the optical disc apparatus and the data about the disc type is stored in the RAM of the optical disc apparatus.

10. An optical disc apparatus comprising:
an optical pickup configured to record data on an optical disc or read data from the optical disc using a laser beam;
a recording/playback system configured to drive a spindle motor, a sled motor, and the optical pickup and process servo signals and recording/playback data;
a ROM configured to store a compressed file;
a RAM configured to temporarily store data; and
a controller configured to control the recording/playback system,
wherein the controller is configured to control the recording/playback system to check the type of a loaded disc, read data about the checked disc type from the compressed file, decompress the read data and store the decompressed data in the RAM.

11. The optical disc apparatus of claim 10, wherein the compressed file includes recording-related data about a plurality of disc types, the recording-related data are separately compressed in the compressed file, position information representing positions at which the recording-related data about the disc types are stored is included in the head of the compressed file, and the controller is configured to selectively read recording-related data about the checked disc type from the compressed file based on the position information.

12. The optical disc apparatus of claim 11, wherein recording-related data respectively corresponding to disc types, manufacturers, and recording speeds are separately compressed in the compressed file, identification information about the disc types, manufacturers, and recording speeds and position information on positions at which the recording-related data about the disc types, manufacturers and recording speeds are stored are included in the head of the compressed file, and the controller is configured to selectively read recording-related data about the checked disc type, the manufacturer, and recording speed of the loaded disc from the compressed file based on the identification information and the position information.

13. The optical disc apparatus of claim 12, wherein default recording-related data about the disc types are compressed in the compressed file, and the controller is configured to selectively read the default recording related data, decompress the default recording related data and store the decompressed data in the RAM if the recording-related data about the manufacturer or recording speed of the checked disc is not included in the compressed file.

14. The optical disc apparatus of claim 10, wherein the compressed file includes servo data compressed separately from the data about the disc types, position information on the position at which the servo data is stored is included in the head of the compressed file, and the controller is configured to selectively read the servo data from the compressed file based on the position information, decompress the servo data and store the decompressed servo data in the RAM.

15. The optical disc apparatus of claim 10, wherein the controller is configured to control the recording/playback system to perform a requested recording operation using the data about the disc type of the loaded disc, stored in the RAM.
